(19) United States
(12) Patent Application Publication
(10) Pub. No.: US 2026/0340686 A1
(43) Pub. Date: Oct. 29, 2026

(54) MECHANISM TO LEVERAGE DEGRADATION RATES ANALYSIS FOR SMART ENTERPRISE HARDWARE TRADE-IN AND RECOMMENDING OPTIMAL RESALE PRICES

(71) Applicant: Dell Products L.P., Round Rock, TX (US)

(72) Inventors: Parminder Singh Sethi, Punjab (IN); Anay Kishore, Bangalore (IN); Praveen Kumar, Noida (IN)

(73) Assignee: Dell Products L.P., Round Rock, TX (US)

(21) Appl. No.: 19/189,546

(22) Filed: Apr. 25, 2025

(51) Int. Cl. G06Q 30/02

(52) U.S. Cl. CPC G06Q 30/0278

(57) ABSTRACT

Methods, system, and non-transitory processor-readable storage medium for a hardware value evaluation system are provided herein. An example method includes receiving, by a hardware value evaluation system, hardware identification data for hardware proposed for trade-in. The hardware value evaluation system calculates a health index for the hardware to analyze a degradation rate of the hardware. The hardware value evaluation system determines a competitive price index by comparing the calculated health index to health indices of similar hardware using K-Nearest Neighbors (KNN) algorithm, and generates a recommended trade-in price for the hardware based on the competitive price index.

### FIELD

The field relates generally to determining an optimal resale price for hardware trade-in, within information processing systems.

### BACKGROUND

Companies offer customers the option to exchange their old working hardware, which no longer meets their business requirements, for enhanced hardware that aligns with their needs.

### SUMMARY

Illustrative embodiments provide techniques for implementing a hardware value evaluation system in a storage system. For example, illustrative embodiments comprise a hardware value evaluation system receiving hardware identification data for hardware proposed for trade-in. The hardware value evaluation system calculates a health index for the hardware to analyze a degradation rate of the hardware. The hardware value evaluation system determines a competitive price index by comparing the calculated health index to health indices of similar hardware using K-Nearest Neighbors (KNN) algorithm. The hardware value evaluation system generates a recommended trade-in price for the hardware based on the competitive price index. Other types of processing devices can be used in other embodiments. These and other illustrative embodiments include, without limitation, apparatus, systems, methods and processor-readable storage media.

### BRIEF DESCRIPTION OF THE DRAWINGS

FIG. 1 illustrates an information processing system including a hardware value evaluation system, in an illustrative embodiment.

FIG. 2 illustrates a flow diagram of a process for a hardware value evaluation system, in an illustrative embodiment.

FIG. 3 illustrates the hardware value evaluation system architecture, in an illustrative embodiment.

FIG. 4 illustrates the historical trade-ins and grouped based on the device types, in an illustrative embodiment.

FIGS. 5 and 6 show examples of processing platforms that may be utilized to implement at least a portion of a hardware value evaluation system embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Described below is a technique for use in implementing a hardware value evaluation system, which technique may be used to receive hardware identification data for hardware proposed for trade-in. The hardware value evaluation system calculates a health index for the hardware to analyze a degradation rate of the hardware. The hardware value evaluation system determines a competitive price index by comparing the calculated health index to health indices of similar hardware using K-Nearest Neighbors (KNN) algorithm. The hardware value evaluation system generates a recommended trade-in price for the hardware based on the competitive price index.

Corporations of often need to plan for upgrades and enrichment of their hardware and infrastructure components. Frequently purchasing expensive hardware, however, may not always be the most cost-effective solution due to the operational and capital expenditures involved. Therefore, there is a need for a system that can assess the capabilities of existing hardware, predict potential failures, provide an optimal price for that hardware as a trade-in, and provide opportunities to enhance the computational ecosystem and overall business stability.

Conventional technologies rely on fixed catalogs for price prediction and lack the ability to learn and adapt. Conventional technologies fail to analyze hardware and determine the number of service requests the hardware has undergone, as well as identify any instances of part replacement, rebranding, or refurbishment within the hardware's sub-parts. Conventional technologies fail to understand the true condition of the hardware and assess its usability by studying the level of degradation. Conventional technologies fail to accurately assess the hardware's potential, predict the likelihood of failures, and determine the appropriate pricing accordingly.

By contrast, in at least some implementations in accordance with the current technique as described herein, an improvement in optimizing generation of a trade-in price is achieved by a hardware value evaluation system that receives hardware identification data for hardware proposed for trade-in. The hardware value evaluation system calculates a health index for the hardware to analyze a degradation rate of the hardware. The hardware value evaluation system determines a competitive price index by comparing the calculated health index to health indices of similar hardware using K-Nearest Neighbors (KNN) algorithm. The hardware value evaluation system generates a recommended trade-in price for the hardware based on the competitive price index.

Thus, a goal of the current technique is to analyze the degradation rate of hardware to identify opportunities for trade-in and provide optimal price recommendations for the hardware. Another goal is to assess the current state, or health index, of hardware within a complex ecosystem by leveraging telemetry data. Another goal is to determine the competitive cost of the hardware based on the analysis of its condition. Another goal is to analyze and evaluate failure and cost-related predictions based on current and historical data, and use these insights to continuously improve and fine-tune the solution. Yet another goal is to provide a system that supports a trade-in process for a wide range of devices across different geographical conditions.

In at least some implementations in accordance with the current technique described herein, the use of a hardware value evaluation system can provide one or more of the following advantages: enhancing the efficiency of the hardware trade-in processes, to ensure accurate pricing, and make informed decisions based on the condition and potential of the hardware, and setting the optimal price for hardware that encourages the customer to trade-in and make a new purchase while still allowing the company to make a profit on re-selling the traded-in hardware.

In contrast to conventional technologies, in at least some implementations in accordance with the current technique as described herein, an improvement in identifying the degradation rate of hardware and establishing a robust mechanism for calculating and recommending optimal resale prices for customer hardware is achieved by a hardware value evaluation system that receives hardware identification data for hardware proposed for trade-in. The hardware value evaluation system calculates a health index for the hardware to analyze a degradation rate of the hardware. The hardware value evaluation system determines a competitive price index by comparing the calculated health index to health indices of similar hardware using K-Nearest Neighbors (KNN) algorithm. The hardware value evaluation system generates a recommended trade-in price for the hardware based on the competitive price index.

In an example embodiment of the current technique, the hardware value evaluation system performs a current condition analysis on the hardware, and determines the health index of the hardware if the hardware meets a threshold for the current condition analysis.

In an example embodiment of the current technique, the hardware value evaluation system deploys a Smart Edge Module (SEM) in a customer environment to collect telemetry data from the hardware.

In an example embodiment of the current technique, the hardware value evaluation system deploys the SEM as a temporary application that automatically cleans up after analysis completion.

In an example embodiment of the current technique, the hardware value evaluation system deploys the SEM in response to receiving a customer trade-in request.

In an example embodiment of the current technique, the hardware value evaluation system analyzes current operational data and health status of hardware components of the hardware, where the hardware components comprise CPU, RAM, motherboard, peripherals, slots, sensors and controllers.

In an example embodiment of the current technique, the hardware value evaluation system evaluates power modules, GPU components, hard drives, FC/NIC modules, and interconnect modules.

In an example embodiment of the current technique, the hardware value evaluation system processes the telemetry data through a pre-trained rule engine to validate the hardware is operating at least at an expected level.

In an example embodiment of the current technique, the hardware value evaluation system calculates the health index based on a mean failure index, and age of the hardware.

In an example embodiment of the current technique, the hardware value evaluation system calculates the health index using a Cumulating Density Function and gamma distribution.

In an example embodiment of the current technique, the hardware value evaluation system retrieves historical data associated with the hardware, the historical data comprising failure history, service history, warranty status, and performance history.

In an example embodiment of the current technique, the hardware value evaluation system calculates a failure coefficient value in year format for a type of hardware based on historical failure data.

In an example embodiment of the current technique, the hardware value evaluation system calculates a value of duration between two possible failures for the type of hardware, and uses the failure coefficient value and the value of duration between two possible failures for the type of hardware to determine the gamma distribution.

In an example embodiment of the current technique, the hardware value evaluation system analyzes trade-in history of similar hardware, and calculates an elevated price index based on probability of failure predictions.

In an example embodiment of the current technique, the hardware value evaluation system identifies the similar hardware by performing peer data analysis using the KNN algorithm.

In an example embodiment of the current technique, the hardware value evaluation system identifies a subset of similar traded devices and calculates failure coefficients and average duration between possible failures for the subset.

In an example embodiment of the current technique, the hardware value evaluation system determines a generic prediction of failure for similar device types, calculates a specific prediction of failure for the hardware, and uses both the generic prediction of failure and the specific prediction of failure to calculate the elevated price index.

In an example embodiment of the current technique, the hardware value evaluation system calculates a percentage difference of a probability of a hardware failure for the hardware as compared to the similar device types.

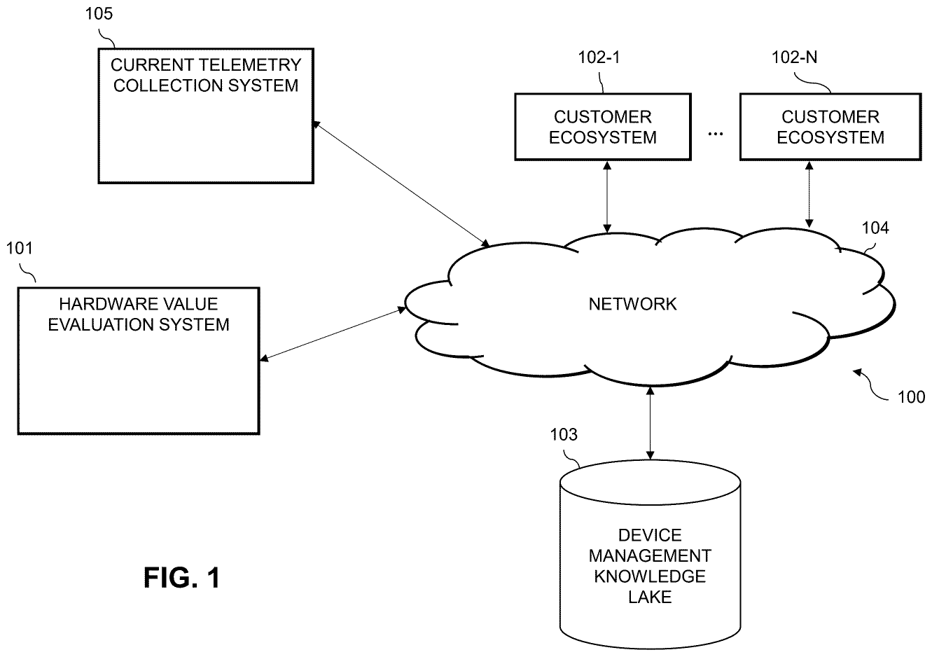

FIG. 1 shows a computer network (also referred to herein as an information processing system) 100 configured in accordance with an illustrative embodiment. The computer network 100 comprises a hardware value evaluation system 101, a current telemetry collection system 105, device management knowledge lake 103, and customer ecosystems 102-N. The hardware value evaluation system 101, current telemetry collection system 105, device management knowledge lake 103, and customer ecosystems 102-N are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. The hardware value evaluation system 101 may reside on a storage system. Such storage systems can comprise any of a variety of different types of storage including network-attached storage (NAS), storage area networks (SANs), direct-attached storage (DAS) and distributed DAS, as well as combinations of these and other storage types, including software-defined storage.

Each of the hardware value evaluation system 101, current telemetry collection system 105, device management knowledge lake 103, and customer ecosystems 102-N may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The hardware value evaluation system 101, current telemetry collection system 105, device management knowledge lake 103, and customer ecosystems 102-N in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the hardware value evaluation system 101 are one or more input-output devices, which illustratively comprise keyboards, displays or other types of input-output devices in any combination. Such input-output devices can be used, for example, to support one or more user interfaces to the hardware value evaluation system 101, as well as to support communication between the hardware value evaluation system 101 and other related systems and devices not explicitly shown. For example, a dashboard may be provided for a user to view results produced by the hardware value evaluation system 101. One or more input-output devices may also be associated with any of the hardware value evaluation system 101, current telemetry collection system 105, device management knowledge lake 103, and customer ecosystems 102-N.

Additionally, the hardware value evaluation system 101 in the FIG. 1 embodiment is assumed to be implemented using at least one processing device. Each such processing device generally comprises at least one processor and an associated memory, and implements one or more functional modules for controlling certain features of the hardware value evaluation system 101.

M ore particularly, the hardware value evaluation system 101 in this embodiment can comprise a processor coupled to a memory and a network interface. The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the hardware value evaluation system 101 to communicate over the network 104 with the hardware value evaluation system 101, current telemetry collection system 105, device management knowledge lake 103, and customer ecosystems 102-N and illustratively comprises one or more conventional transceivers.

A hardware value evaluation system 101 may be implemented at least in part in the form of software that is stored in memory and executed by a processor, and may reside in any processing device. The hardware value evaluation system 101 may be a standalone plugin that may be included within a processing device.

It is to be understood that the particular set of elements shown in FIG. 1 for hardware value evaluation system 101 involving the current telemetry collection system 105, device management knowledge lake 103, and customer ecosystems 102-N of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the hardware value evaluation system 101 can be on and/or part of the same processing platform.

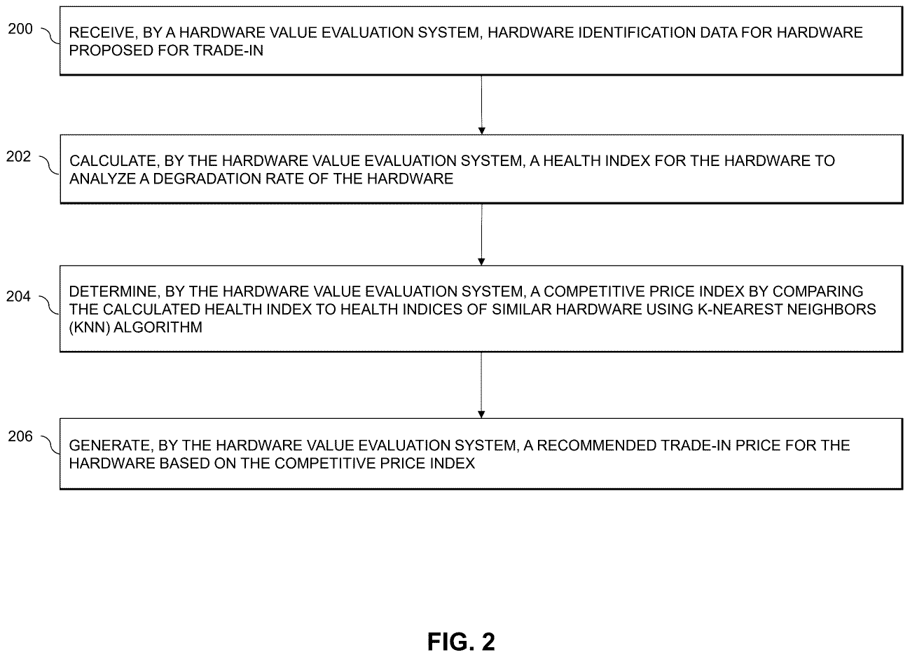

An exemplary process of hardware value evaluation system 101 in computer network 100 will be described in more detail with reference to, for example, the flow diagram of FIG. 2. FIG. 2 is a flow diagram of a process for execution of the hardware value evaluation system 101 in an illustrative embodiment. It is to be understood that this particular process is only an example, and additional or alternative processes can be carried out in other embodiments.

At 200, the hardware value evaluation system 101 receives hardware identification data for hardware proposed for trade-in. In an example embodiment, the hardware value evaluation system 101 performs a current condition analysis on the hardware and determines the health index of the hardware if the hardware meets a threshold for the current condition analysis.

In an example embodiment, the hardware value evaluation system 101 deploys a Smart Edge Module (SEM) in a customer environment to collect telemetry data from the hardware. In an example embodiment, the SEM is deployed by the hardware value evaluation system 101 from the current telemetry collection system 105 to the customer ecosystem 102-N. In an example embodiment, the SEM is an edge computing based deployable component. In an example embodiment, the SEM is only deployed by an admin on any operating system architecture based on application packaging. In an example embodiment, the SEM is deployed in response to receiving a customer trade-in request, for example, initiated by a customer on the customer ecosystem 102-N. Once deployed, the SEM collects different types of relevant data on the hardware to be traded in. The SEM then transmits the collected data back to the hardware value evaluation system 101.

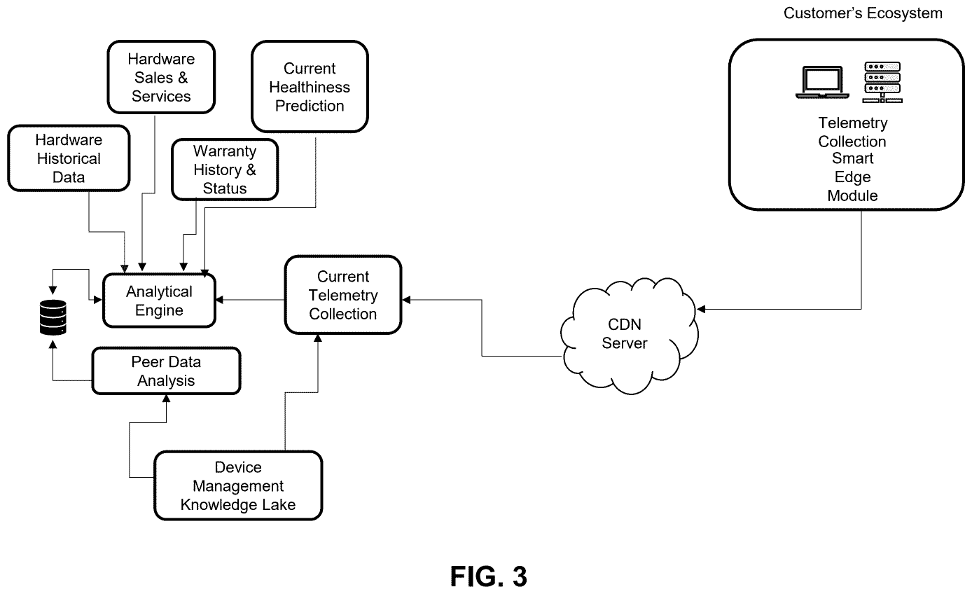

In an example embodiment, the SEM is downloaded and deployed in a customer environment (i.e., such as customer ecosystem 102-N) on a standalone system, and may perform an analysis on one or more devices at a time. In an example embodiment, the SEM may be configured by users with elevated access (such as root/sudo/admin, etc.). The SEM can be deployed on any supported operating system platform based on application packaging. In an example embodiment, a user may choose the version based on availability of a standalone system in their datacenter. In an example embodiment, the SEM performs different types of probes and collects telemetry data that is uploaded to a backend server for further analysis. FIG. 3 illustrates the hardware value evaluation system architecture.

In an example embodiment, the hardware value evaluation system 101 deploys the SEM as a temporary application that automatically cleans up after analysis completion. In an example embodiment, based on the customer's settings, the SEM may either stay in the environment for future use, or perform an uninstall and auto clean up after the analysis is completed.

In an example embodiment, the SEM performs a current telemetry collection and uploads it to a backend server. In an example embodiment, the current telemetry collection system 105 analyzes current operational data and health status of hardware components of the hardware, where the hardware components comprise Central Processing Unit (CPU), Random Access Memory (RAM), motherboard, peripherals, slots, sensors and controllers. In an example embodiment, the current telemetry collection system 105 evaluates power modules, Graphics Processing Unit (GPU) components, hard drives, Fiber Channel/Network Interface Card (FC/NIC) modules, and interconnect modules. In an example embodiment, the current telemetry collection system 105 performs a full study of the collected data based on several factors. The current telemetry collection system 105 evaluates the condition of all major hardware parts, such as CPU, RAM s, motherboard, fan modules, etc. The current telemetry collection system 105 evaluates the condition of peripherals, such as the power module, GPU, hard drives, etc. The current telemetry collection system 105 evaluates the condition of the slots, such as Peripheral Component Interconnect Express (PCIe), Universal Serial Bus (USB), serial, etc. The current telemetry collection system 105 evaluates the condition of the sensors, such as temperature, speed, hot swap, tec. The current telemetry collection system 105 evaluates the condition of the controllers, such as Serial Attached Small Computer System Interface (SCSI)/Serial Advanced Technology Attachment (SAS/SATA), firmware, etc. The current telemetry collection system 105 evaluates the condition of any additional parts, such as FC/NIC, interconnect modules, etc.

In an example embodiment, after a full analysis of the parts in the proposed trade-in device (i.e., the device), the hardware value evaluation system 101 ensures there are no failures in any parts or sub-parts. The hardware value evaluation system 101 processes telemetry data through a pre-trained rule engine to validate the hardware is operating at least at an expected level. In an example embodiment, only devices that are found to be working on optimal levels are considered fit for an elevated price consideration for trade-in. For example, if the hardware has crossed the supported period, such as 5 years, then the hardware value evaluation system 101 may determine that no elevated pricing is offered and stringent hardware validation is performed prior to accepting the device for trade-in. The hardware value evaluation system 101 may determine that the warranty period has expired and a warranty extension is allowed only after a study of the health index of the device. In an example embodiment, the hardware value evaluation system 101 applies rules to the hardware such as if the hardware is in-warranty and in its optimal state, then an elevated price is offered, or if the hardware has a history of mishandling or major failures, then the trade-in is not accepted.

At 202, the hardware value evaluation system 101 calculates a health index for the hardware to analyze a degradation rate of the hardware. In an example embodiment, the hardware value evaluation system 101 calculates the health index based on a mean failure index, and age of the hardware. In an example embodiment, the hardware value evaluation system 101 calculates the health index using a Cumulating Density Function and gamma distribution.

In an example embodiment, the hardware value evaluation system 101 retrieves historical data associated with the hardware, the historical data comprising failure history, service history, warranty status, and performance history. The historical data, such as failure and claims, is used to find out the details of past failures and warranty claims. The hardware sales and service history are used to understand the cases created in the past and the severity of the issues that occurred post sale of the hardware. The warranty history and status, along with any history of rebranding, relocation, or getting refurbished is also obtained from the device management knowledge lake 103. The hardware value evaluation system 101 obtains hardware pricing data from the device management knowledge lake 103, for example, pricing data being offered for different types of hardware that have been or are actively being traded-in. This data is used to analyze and calculate a competitive pricing for all device types and stored as a static factor for calculation of new competitive pricing that is offered for new hardware trade-in.

When the customer initiates a trade-in request, the hardware value evaluation system 101 identifies the device based on its service tag or serial number. The hardware value evaluation system 101 gathers historical and telemetry data for that hardware (i.e., the device) from different sub systems, such as warranty, sales, service to determine details such as date of sale of hardware and support period validity, history of major failure/mishandling/crashes/damage, service history (i.e., details of changes in hardware or services provided, case created and dispatches), performance history, failures or degradation in any parts, warranty claims history, rebranding or relocation of hardware (if any), and customization or refurbishment records (if any). In an example embodiment, if the hardware value evaluation system 101 determines known or probable causes of failures or degradation, the hardware value evaluation system 101 determines the device is not eligible for a trade-in at elevated prices, and a lower-level price may be offered for trade-in. In an example embodiment, hardware value evaluation system 101 obtains the customer technical infrastructure data (i.e., the device, hardware, application, services, etc.) that is stored in the device management knowledge lake 103. Through the device management knowledge lake 103, the hardware value evaluation system 101 obtains specific data regarding when a particular hardware or infrastructure is failing. The devices determined to be free from such issues will be considered for further calculations and tests. Thus, the hardware value evaluation system 101 determines the health index of the hardware if the hardware meets a threshold for the current condition analysis.

In an example embodiment, the hardware value evaluation system 101 calculates a failure coefficient value in year format for a type of hardware based on historical failure data. Based on the historical data obtained by the hardware value evaluation system 101 from the device management knowledge lake 103, the hardware value evaluation system 101 calculates a mean value that is converted into year format and stored as the failure co-efficient, λ. The hardware value evaluation system 101 calculates the value of duration between two possible failures (identified as “a”) for the type of hardware which can then be used in the calculation of a possibility of occurrence of a failure at a given point. In an example embodiment the hardware value evaluation system 101 calculates the “λ” and “a” for all known types of hardware to be used in calculating the current healthiness of the device.

In an example embodiment, the hardware value evaluation system 101 uses the failure coefficient value, λ, and the value of duration between two possible failures, “a”, for the type of hardware to determine the gamma distribution. The gamma distribution is calculated as follows:

$$Gamma Distribution F ( x ) = \frac{{x}^{a - 1} {e}^{- λ x} {λ}^{a}}{Γ ( a )} , x \geq 0$$

In an example embodiment, a device has a failure duration “a” as 0.5 years (which is the duration between occurrence of two possible failures) and a failure co-efficient value, λ, as 3 years. The cumulative probability of failures after 2 years is almost 0.7517, meaning the hardware has a 75.17% chance of failure after it has been in use for 2 years. The hardware value evaluation system 101 determines a life expectancy and reliability of a given hardware with or without an applied warranty taken into consideration. The higher the value of the gamma distribution, the higher the reliability and the higher the chances of the device life expectancy after hardware/device trade-in from the customer.

At 204, the hardware value evaluation system 101 determines a competitive price index by comparing the calculated health index to health indices of similar hardware using K-Nearest Neighbors (KNN) algorithm. In an example embodiment, the hardware value evaluation system 101 analyzes the trade-in history of similar hardware and calculates an elevated price index based on probability of failure predictions.

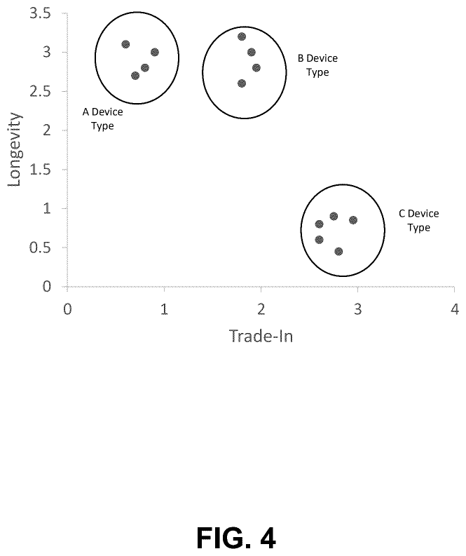

In an example embodiment, the hardware value evaluation system 101 obtains historical data related to hardware trade-in for different families of hardware from the device management knowledge lake 103 to classify these operations in different families. These families are based on types of hardware, for example, server/storage/networking, and region/country etc. The hardware value evaluation system 101 maps the longevity data to these trade-ins (i.e., the current condition of hardware or duration of use of hardware post trade-in). FIG. 4 illustrates the historical trade-ins and grouped based on the device types. The grouping may also be performed based on countries/regions etc. FIG. 4 illustrates the co-relation of the hardware trade-in of devices and the related longevity period. The KNN analysis and mapping of the historical data assists in relating the current device (proposed for trade-in) and its condition. Once a device is accepted for trade-in, the data related to that device is entered into the device management knowledge lake 103 and fed into this model to further enhance the coverage and learning.

In an example embodiment, the hardware value evaluation system 101 identifies similar hardware (to the device proposed for trade-in) by performing peer data analysis using the KNN algorithm. The peer data analysis is performed to understand the historical trade-in data of similar hardware and success rate of that hardware. Using the KNN analysis, the hardware value evaluation system 101 identifies the price(s) offered for similar device type trade-in, the performance of similar devices post trade-in by customer, and ecosystems of devices from where trade-ins were accepted, such as region, temperatures, zone, etc. Based on the KNN identification, the hardware value evaluation system 101 identifies a subset of similar traded devices and calculating failure coefficients (“λ”) and average duration between possible failures for the subset (“a”). The hardware value evaluation system 101 calculates the cumulative possibility of failure of the current device (being offered for trade-in) with the gamma distribution, as discussed above. Thus, the hardware value evaluation system 101 obtains a prediction of failure for the current device (for which trade-in is being accepted) in numerical form, the co-efficiency and related factors to understand the device reliability of a smaller subset of devices for which trade-in transactions were performed previously, and the cost and related information for the previous transactions.

In an example embodiment, the hardware value evaluation system 101 determines a generic prediction of failure for similar device types, P1. The hardware value evaluation system 101 calculates a specific prediction of failure for the hardware, P2, indicating the possibility of failure and reliability of the current device. The hardware value evaluation system 101 uses both the generic prediction of failure and the specific prediction of failure to calculate the elevated price index. In an example embodiment, the hardware value evaluation system 101 calculates the elevated price index by determining a percentage difference of a probability of a hardware failure for the hardware as compared to the similar device types. The elevated price index is calculated as follows:

EPI=100×(P1−P2)/P1

The elevated price index provides data as to how much is the percentage of difference in probability of failure for the hardware trade-in than a generic similar hardware. The elevated price index identifies the benefit of providing an elevated price for the current hardware (i.e., the device proposed for trade-in). For example, if the generic prediction of failure for the device, P1 is 80%, and the prediction of failure of the proposed trade-in device, P2 is 70%, then the chances of the proposed trade-in device operating longer for the same duration is 12.5%. Organizations may use this data to determine an estimated price index for any type of hardware trade-in.

At 206, the hardware value evaluation system 101 generates a recommended trade-in price for the hardware based on the competitive price index.

The above-described illustrative embodiments provide significant advantages relative to conventional approaches. For example, some embodiments are configured to analyze the degradation rate of hardware to identify opportunities for trade-in and provide optimal price recommendations for the hardware. These and other embodiments can effectively improve sales, revenue, customer retention, and brand perception. Embodiments disclosed herein analyze and evaluate failure and cost-related predictions based on current and historical data, and uses these insights to continuously improve and fine-tune the solution. Embodiments disclosed herein enhance the efficiency of the hardware trade-in processes, ensure accurate pricing, and make informed decisions based on the condition and potential of the hardware. Embodiments disclosed herein set the optimal price for hardware that encourages the customer to trade-in and make a new purchase while still allowing the company to make a profit on re-selling the traded-in hardware.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the information processing system 100. For example, containers can be used to implement respective processing devices providing compute and/or storage services of a cloud-based system. A gain, containers may be used in combination with other virtualization infrastructure such as virtual machines implemented using a hypervisor.

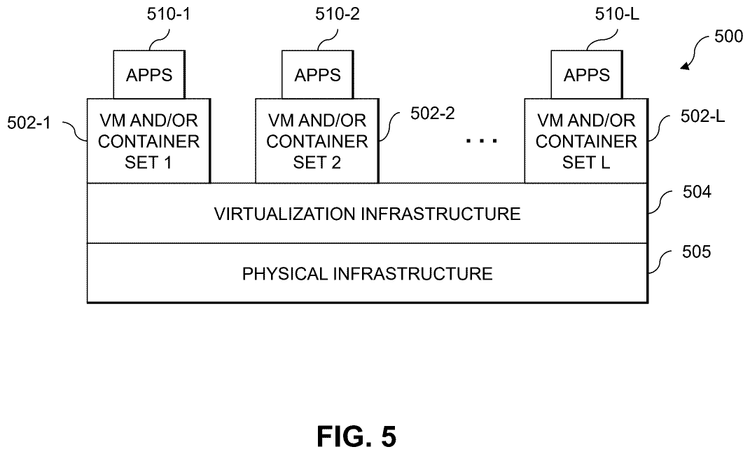

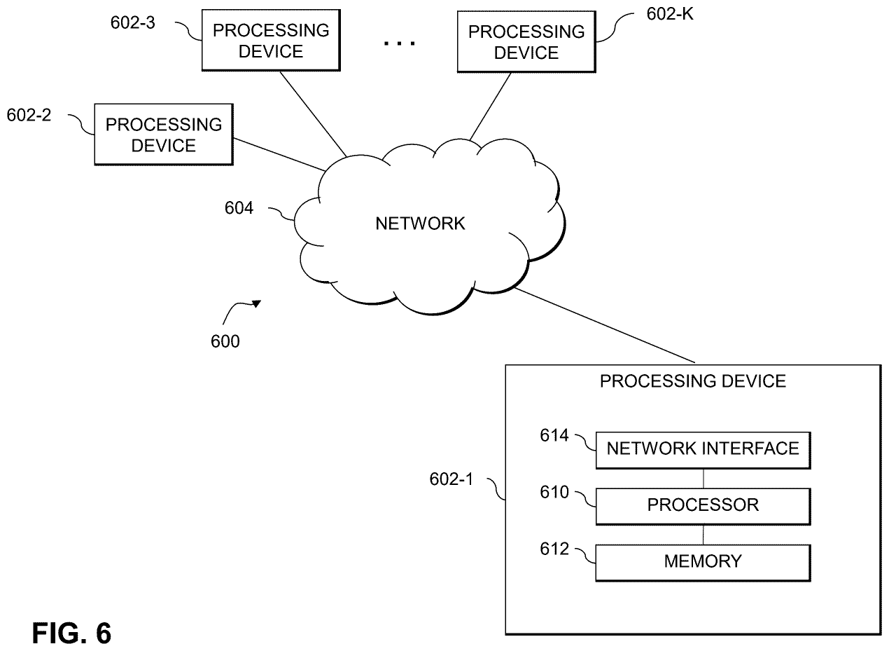

Illustrative embodiments of processing platforms will now be described in greater detail with reference to FIGS. 5 and 6. Although described in the context of the information processing system 100, these platforms may also be used to implement at least portions of other information processing systems in other embodiments.

FIG. 5 shows an example processing platform comprising cloud infrastructure 500. The cloud infrastructure 500 comprises a combination of physical and virtual processing resources that are utilized to implement at least a portion of the information processing system 100. The cloud infrastructure 500 comprises multiple virtual machines (VMs) and/or container sets 502-1, 502-2, . . . 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

The cloud infrastructure 500 further comprises sets of applications 510-1, 510-2, . . . 510-L running on respective ones of the VMs/container sets 502-1, 502-2, . . . 502-L under the control of the virtualization infrastructure 504. The VMs/container sets 502 comprise respective VMs, respective sets of one or more containers, or respective sets of one or more containers running in VMs.

In some implementations of the FIG. 5 embodiment, the VMs/container sets 502 comprise respective VMs implemented using virtualization infrastructure 504 that comprises at least one hypervisor. A hypervisor platform may be used to implement a hypervisor within the virtualization infrastructure 504, where the hypervisor platform has an associated virtual infrastructure management system. The underlying physical machines comprise one or more distributed processing platforms that include one or more storage systems. The VMs can implement at least portions of the hardware value evaluation system 101 in illustrative embodiments.

In other implementations of the FIG. 5 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system. Such containers can implement at least portions of the hardware value evaluation system 101 in illustrative embodiments.

As is apparent from the above, one or more of the processing modules or other components of the information processing system 100 may each run on a computer, server, storage device or other processing platform element. A given such element is viewed as an example of what is more generally referred to herein as a “processing device.” The cloud infrastructure 500 shown in FIG. 5 may represent at least a portion of one processing platform. Another example of such a processing platform is processing platform 600 shown in FIG. 6.

The processing platform 600 in this embodiment comprises a portion of the information processing system 100 and includes a plurality of processing devices, denoted 602-1, 602-2, 602-3, . . . 602-K, which communicate with one another over a network 604.

The network 604 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 602-1 in the processing platform 600 comprises a processor 610 coupled to a memory 612.

The processor 610 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory 612 comprises random access memory (RAM), read-only memory (ROM) or other types of memory, in any combination. The memory 612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

A gain, the particular processing platform 600 shown in the figure is presented by way of example only, and the information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. M any variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
receiving, by a hardware value evaluation system, hardware identification data for hardware proposed for trade-in;
deploying, by the hardware value evaluation system, a Smart Edge Module (SEM) in a customer environment to collect telemetry data from the hardware in response to receiving a customer trade-in request, wherein the SEM performs active probes of the hardware components and transmits the collected telemetry data to a backend server for further analysis;
processing the telemetry data through a pre-trained rule engine to validate the hardware is operating at least at an expected level;
calculating, by the hardware value evaluation system, a health index for the hardware to analyze a degradation rate of the hardware, wherein calculating the health index comprises calculating the health index using a Cumulative Density Function and gamma distribution, the gamma distribution determined using a failure coefficient value in year format for a type of hardware and a value of duration between two possible failures for the type of hardware;
determining, by the hardware value evaluation system, a competitive price index by comparing the calculated health index to health indices of similar hardware using K-Nearest Neighbors (KNN) algorithm; and
generating, by the hardware value evaluation system, a recommended trade-in price for the hardware based on the competitive price index, wherein the method is implemented by at least one processing device comprising a processor coupled to a memory.

2. The method of claim 1 wherein receiving, by the hardware value evaluation system, the hardware identification data for hardware comprises:
performing a current condition analysis on the hardware; and
determining the health index of the hardware if the hardware meets a threshold for the current condition analysis.

3. The method of claim 1 wherein the Smart Edge Module (SEM), once deployed, analyzes current operational data and health status of hardware components of the hardware, the hardware components comprising Central Processing Unit (CPU), Random Access Memory (RAM), motherboard, peripherals, slots, sensors, and controllers.

4. The method of claim 3 wherein deploying the Smart Edge Module comprises:
deploying the SEM as a temporary application that automatically cleans up after analysis completion.

5. The method of claim 1 wherein the SEM, once deployed, evaluates power modules, Graphics Processing Unit (GPU) components, hard drives, Fiber Channel/Network Interface Card (FC/NIC) modules, and interconnect modules.

6. (canceled)

7. (canceled)

8. The method of claim 1 wherein processing the telemetry data through the pre-trained rule engine comprises:
applying rules such that: hardware that is in-warranty and operating at an optimal state is eligible for an elevated trade-in price;
hardware that has crossed its supported operational period is subject to stringent hardware validation prior to acceptance for trade-in; and
hardware having a history of mishandling or major failures is not accepted for trade-in.

9. (canceled)

10. The method of claim 1 wherein calculating the health index for the hardware further comprises:
calculating the health index based on a mean failure index and an age of the hardware, in addition to the Cumulating Density Function and gamma distribution.

11. The method of claim 10 wherein calculating the health index using the Cumulating Density Function and gamma distribution comprises:
retrieving historical data associated with the hardware, the historical data comprising failure history, service history, warranty status, and performance history.

12. The method of claim 11 wherein calculating the failure coefficient value in year format comprises:
calculating, for each of a plurality of known hardware types, a mean value derived from historical failure data and converting that mean value into year format, and storing the failure coefficient values for each hardware type for use in calculating health indices for hardware proposed for trade-in.

13. The method of claim 12 wherein using the failure coefficient value and the value of duration between two possible failures to determine the gamma distribution further comprises:
calculating a cumulative probability of failure for the hardware at a given point in time based on the gamma distribution; and determining a life expectancy and reliability of the hardware based on the cumulative probability of failure, wherein a higher gamma distribution value indicates higher reliability and higher life expectancy of the hardware post-trade-in.

14. The method of claim 1 wherein determining the competitive price index comprises:
analyzing trade-in history of similar hardware; and
calculating an elevated price index based on probability of failure predictions.

15. The method of claim 14 wherein analyzing the trade-in history of the similar hardware comprises:
identifying the similar hardware by performing peer data analysis using the KNN algorithm.

16. The method of claim 15 wherein identifying the similar hardware by performing peer data analysis using the KNN algorithm comprises:
identifying a subset of similar traded devices and calculating failure coefficients and average duration between possible failures for the subset.

17. The method of claim 14 wherein calculating the elevated price index comprises:
determining a generic prediction of failure for similar device types;
calculating a specific prediction of failure for the hardware; and
using both the generic prediction of failure and the specific prediction of failure to calculate the elevated price index.

18. The method of claim 17 wherein using both the generic prediction of failure and the specific prediction of failure to calculate the elevated price index comprises:
calculating a percentage difference of a probability of a hardware failure for the hardware as compared to the similar device types.

19. A system comprising:
at least one processing device comprising a processor coupled to a memory;
the at least one processing device being configured:
to receive, by a hardware value evaluation system, hardware identification data for hardware proposed for trade-in;
to deploy, by the hardware value evaluation system, a Smart Edge Module (SEM) in a customer environment to collect telemetry data from the hardware in response to receiving a customer trade-in request, wherein the SEM performs active probes of the hardware components and transmits the collected telemetry data to a backend server for further analysis;
to process the telemetry data through a pre-trained rule engine to validate the hardware is operating at least at an expected level;
to calculate, by the hardware value evaluation system, a health index for the hardware to analyze a degradation rate of the hardware, wherein calculating the health index comprises calculating the health index using a Cumulative Density Function and gamma distribution, the gamma distribution determined using a failure coefficient value in year format for a type of hardware and a value of duration between two possible failures for the type of hardware;
to determine, by the hardware value evaluation system, a competitive price index by comparing the calculated health index to health indices of similar hardware using K-Nearest Neighbors (KNN) algorithm; and
to generate, by the hardware value evaluation system, a recommended trade-in price for the hardware based on the competitive price index.

20. A computer program product comprising a non-transitory processor-readable storage medium having stored therein program code of one or more software programs, wherein the program code when executed by at least one processing device causes the at least one processing device:
to receive, by a hardware value evaluation system, hardware identification data for hardware proposed for trade-in;
to deploy, by the hardware value evaluation system, a Smart Edge Module (SEM) in a customer environment to collect telemetry data from the hardware in response to receiving a customer trade-in request, wherein the SEM performs active probes of the hardware components and transmits the collected telemetry data to a backend server for further analysis;
to process the telemetry data through a pre-trained rule engine to validate the hardware is operating at least at an expected level;
to calculate, by the hardware value evaluation system, a health index for the hardware to analyze a degradation rate of the hardware, wherein calculating the health index comprises calculating the health index using a Cumulative Density Function and gamma distribution, the gamma distribution determined using a failure coefficient value in year format for a type of hardware and a value of duration between two possible failures for the type of hardware;
to determine, by the hardware value evaluation system, a competitive price index by comparing the calculated health index to health indices of similar hardware using K-Nearest Neighbors (KNN) algorithm; and
to generate, by the hardware value evaluation system, a recommended trade-in price for the hardware based on the competitive price index.
